(19) United States
(12) Patent Application Publication
(10) Pub. No.: US 2005/0034100 A1
(43) Pub. Date: Feb. 10, 2005

(54) Visual programming method and system thereof

(76) Inventor: Hanbai Liu, Hacienda Heights, CA (US)

Correspondence Address: Raymond Y. Chan, Suite 128, 108 N. Ynez Ave., Monterey Park, CA, 91754, US

(21) Appl. No.: 10/633,341

(22) Filed: Aug. 4, 2003

(51) Int. Cl. G06F 9/44

(52) U.S. Cl. 717/105

(57) ABSTRACT

A visual programming system includes one or more function modules each of which is provided with an applicable functional program or command stored in computer executable language in a processing unit to accomplish a substantial applicable function, one or more determination modules each of which is provided with a determining test stored in computer executable language in the processing unit, and commanding flow arrows connecting the function modules and determination modules in a predetermined sequence to construct a visual graphic program, wherein the visual graphic program can be compiled to machine readable codes by sending information outputted from each of the function modules and determination modules to input into another the function module or determination module that is connected thereto by the commanding flow arrows so as to construct a finish program in computer executable language in a processing unit.

### BACKGROUND OF THE PRESENT INVENTION

1. Field of Invention

The present invention relates to programming method, and more particularly to a visual programming method and system thereof that allows users to produce and/or amend computer programs by constructing function modules and/or determination modules with commanding flow arrows, without the need of learning, understanding and memorizing rules and syntax of advanced programming languages and avoid the trouble of computing and debugging lengthy source codes.

2. Description of Related Arts

While computers are getting more and more popular, most users still find themselves being confined by designed programs and software which are developed in the hope of satisfying all who uses them. Users can hardly change the software themselves, despite how they find the software difficult to use. The reason is that programs and software designing and computing requires knowledge and skills in conventional advanced programming languages such as Fortran, C, C++, and Java. Indeed, these programming languages provide high flexibility for creating programs or software, but, however, are difficult to understand and require a strong memory of all the syntax.

Even those who have the skills and knowledge in those programming languages will find getting a set of source code to compile frustrating. As soon as there is a slightest syntax error, such as a missing close bracket, the whole program simply cannot compile. Debugging requires a huge amount of time and expertise. It is basically impossible for people having average computing knowledge to custom make their own software, despite how good an idea a person has. Using conventional programming languages, an idea must be converted into source code before it can be developed into software.

It would be even more difficult to try to improve on the already written program later on due to the fact that source codes are very difficult to follow and understand. A lot of people have shared the same experience of rather rewriting the whole program from scratch than trying to improve on the existing source code.

Conventional programmable software comprises an editor and a compiler. The editor allows a user to input a desired set of source code using human readable codes. These human readable codes are not understandable by machines. As a result, after a set of source codes has been edited through the editor using the particular compiled language that the programmable software recognizes, for example C++ is recognized by Microsoft Visual C++, the compiler converts the set of source code into machine readable codes of a computer executable language so that the computer can understand the command and perform the desired functions of the users.

Even though conventional programmable software provide a high flexibility in creating programs and software, they are only beneficial to people who have acquired the knowledge in how to compute source codes in advanced programming languages. In order to custom make a program to operate the business, some companies hire programmers to produce their own programs to fit their private needs and applications. However, when the companies improve or modify their managements and operations, they cannot amend or modify their programs to adapt the corresponding changes without the help of the programmers who have the source codes of their programs that substantially creates a lot troublesome to the company users.

Therefore, in order to allow ordinary people to enjoy the flexibility of creating and amending programs and software according to their own need and desire without having to go into the trouble of learning, understanding and memorizing awkward syntax of advanced programming languages, a better source code editor must be created.

### SUMMARY OF THE PRESENT INVENTION

A main object of the present invention is to provide a visual programming method and system thereof that allows users to produce computer programs by constructing function modules and/or determination modules with commanding flow arrows, without the need of learning, understanding and memorizing rules and syntax of advanced programming languages and avoid the trouble of computing and debugging lengthy source codes.

Another object of the present invention is to provide a visual programming method and system thereof for computer programs so as to allow users to amend the computer programs anytime to fit their private needs and applications by themselves without the need of learning, understanding and memorizing rules and syntax of advanced programming languages and avoid the trouble of computing and debugging lengthy source codes.

Another object of the present invention is to enable users to input a program without having to understand any particular advanced program languages.

Another object of the present invention is to provide a visual programming method and system thereof, wherein machine readable codes of programs designed by professional programmers can be converted back into human readable codes, allowing users to perform changes to the programs.

Another object of the present invention is to provide a visual programming method and system thereof, wherein the user selectable commands are in the form of boxes and lines, as a result, the outlook of the finished program is as simple as like a flow chart and the production of the finished program is as easy as making a flow chart too.

In order to accomplish the above objects, the present invention provides a visual programming system which comprises:
one or more function modules each of which is provided with an applicable functional program or command stored in computer executable language in a processing unit to accomplish a substantial applicable function;
one or more determination modules each of which is provided with a determining test stored in computer executable language in the processing unit; and
commanding flow arrows connecting the function modules and determination modules in a predetermined sequence to construct a visual graphic program which is compiled to machine readable codes by sending information outputted from each of the function modules and determination modules to input into another the function module or determination module that is connected thereto by the commanding flow arrows so as to construct a finish program in the computer executable language in the processing unit.

### BRIEF DESCRIPTION OF THE DRAWINGS

FIG. 1 illustrates the relationship between the user editing interface, compiler and the conversion rules database according to a preferred embodiment of the present invention.

FIG. 2 illustrates the user editing interface and its functions according to the above preferred embodiment of the present invention.

FIG. 3 illustrates a visual graphic program for a value test according to the above preferred embodiment of the present invention.

FIG. 4 illustrates a “For Loop” visual graphic program according to the above preferred embodiment of the present invention.

FIG. 5 illustrates a “Do-While Loop” visual graphic program according to the above preferred embodiment of the present invention.

### DETAILED DESCRIPTION OF THE PREFERRED EMBODIMENT

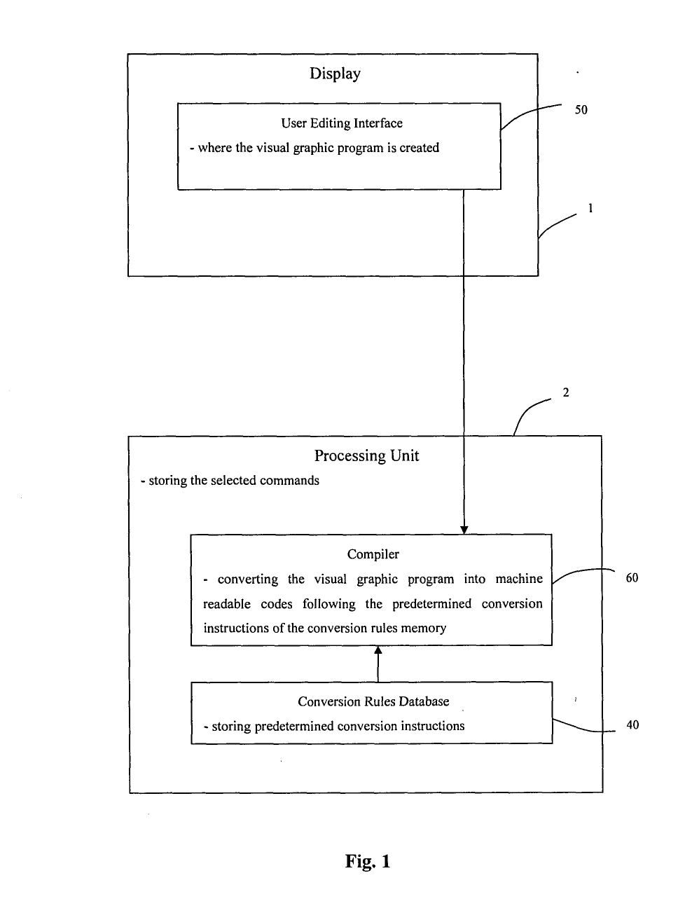

According to FIG. 1 to FIG. 5, a visual programming method and system thereof according to a preferred embodiment of the present invention is illustrated. The visual programming system comprises one or more function modules 10, one or more determination modules 20, and commanding flow arrows 30 connecting the function modules 10 and the determination modules 20, if any, in a designated construction to form a finished visual graphic program.

Each of the function modules 10 comprises an applicable functional program or command stored in computer executable language in a processing unit 2 to accomplish a substantial applicable function. The function module 10 has at least an information input 11 for inputting data and an information output 12 for outputting computed data. The applicable function can be (i) an independent process such as “Compute the Inputted Data with a Specific Formula”, “Compile Saved Process”; (ii) a controllable object such as “Turn Off the Television”; (iii) an event such as, “Import Event” and “Add New Record”, or (iv) a matter such as “Begin Affair” and “Variable”, etc.

Each of the determination modules 20 comprises a selection program or command (Determining Test) stored in computer executable language in the processing unit 2 to determine where the output value or information from a specific function module 10 should input into another function module 10. The determination module 20 has a determination input 21, a “True” output 22 and a “False” output 23 for information. When the computed output information from the previous function module 10 matches the selection program or command of the determination module 20, the output information is output from the “True” output 22. If the computed output information from the previous function module 10 does not match the selection program or command of the determination module 20, the output information is output from the “False” output 23.

The commanding flow arrows 30 are used to connect the information inputs and outputs of the function modules 10 and the determination modules 20 together in a specific sequence to construct a program. When a commanding flow arrow 30 connects the information output 11 of a first function module 10 or the “True” output 22 or “False” output 23 of a first determination module 20 to the information input 11 of a second function module 10 or the determination input 21 of a second determination module 20, the information output from the first function module 10 of the first determination module 20 is input into the second function module 10 of the second determination module, that is the applicable functional program or command in computer executable language of the first function module 10 or the determining test of the first determination module 20 will be combined with the applicable functional program or command in computer executable language of the second function module 10 or the determining test of the second determination module 20.

According to the present invention, although the human readable codes are not required because the construction of the function modules 10, determination modules 20 and commanding flow arrows 30 are displayed by the computer via the monitor thereof as human visual graphic program which directly represents the computer executable language to be stored in the computer to operate and function, in order to better illustrate the present invention, the conventional human readable codes, i.e. the source codes, of conventional program languages such as C++ and Java can be used as an interface between the visual graphic program and the computer executable language.

In addition, the conventional human readable source codes of the current program can also convert and arrange the source codes into different function modules 10 and determination modules 20 of the visual graphic program of the present invention according to a conversion rules database 40. The visual programming system also includes a user editing interface 50 to enable the user to construct the visual graphic program by selecting the required function modules 10 and, if necessary, the appropriate determination modules 20 and linking the selected function modules 10 and determination modules 20 by the commanding flow arrows 30, and a compiler 60 which is used to convert the human readable source code program or the visual graphic program into the machine readable codes of the computer executable language following the predetermined conversion instructions of the conversion rules memory.

The user editing interface 50 comprises user selectable commands, allowing users to create a program by selecting commands from the user editing interface 50 on a human viewable display 1 of the computer, wherein each of the selectable commands has their own predetermined definition, a storing command to create storage spaces inside the processing unit 2 of the computer so that the visual graphic program of selected commands are to be stored within the processing unit 2 and a compiling command to instruct the compiler to start converting the selected commands into the machine readable codes upon receiving the compiling command.

The conversion rules database 40 comprises predetermined conversion instructions of converting selected commands to machine readable codes. The compiler 60 comprises a compiling signal receiver to receive the compiling signal from the user editing interface. Upon receiving the compiling signal, the compiler 60 starts to convert the selected commands into machine readable codes.

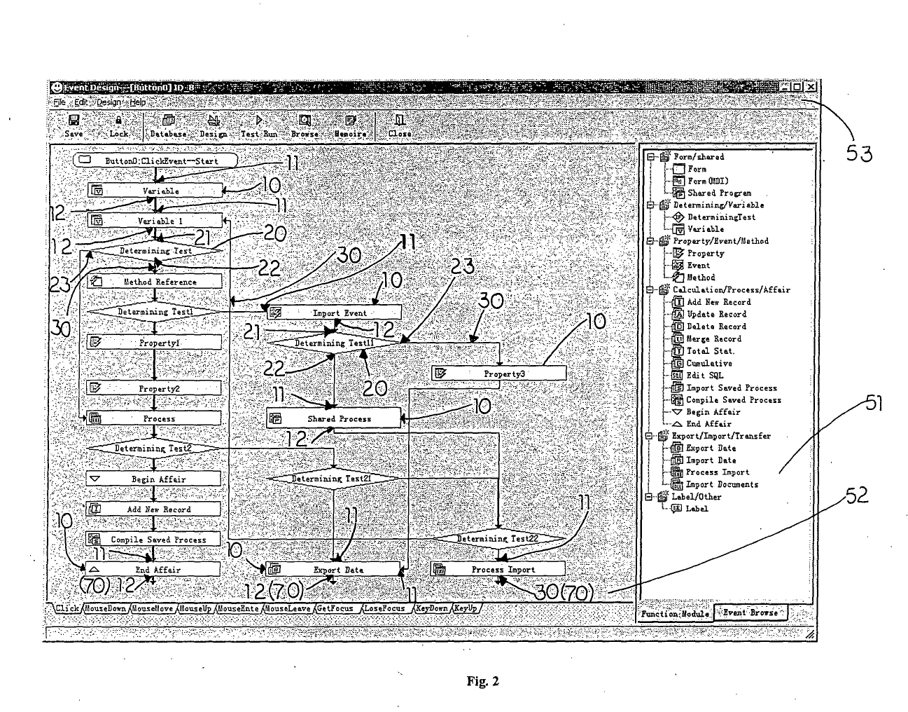

According to FIG. 2, the user editing interface 50 comprises a command selection panel 51, a selected command panel 52, and a file management panel 53. The command selection panel 51 comprises selectable commands, including determining test commands such as those that are equivalent to “If-Then-Else”, “Case Loop”, “For Loop”, “Do-While Loop” in conventional programming languages, commanding flow arrows 30 representing the direction of flow of the program and functional commands. When a command is selected from the command selection panel 51, the selected command appears in the selected command panel 52. By arranging selected commands into a flow chart form, the visual graphic program is completed.

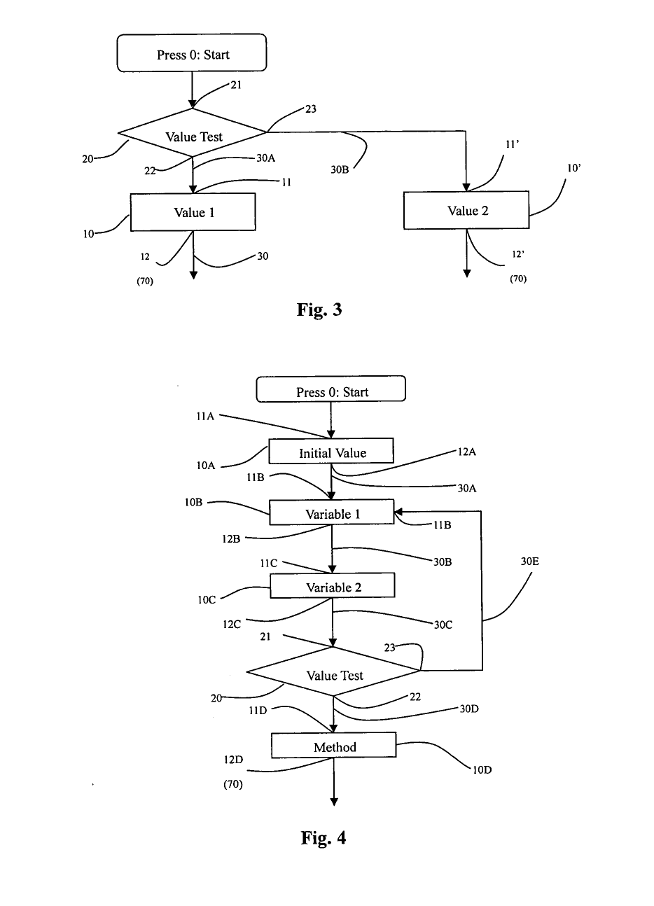

Referring to FIG. 3, the direction of the command flow arrows 30 represents the flow of the visual graphic program. There are two command flow arrows 30 pointing away from a “value test” of the determination module 20 since there are two possible return values, i.e. “True” and “False”. A main commanding flow arrow 30A usually follows the “True” returned value of the determination module 20, while a branch commanding flow arrow 30B follows the “False” returned value of the determination module 20. There are two types of commands, “multi-input and single output” command and “multi-input and double output” command. When an output 12 of a command of the function module 10 is not connected to any other commands of other function modules 10, the output information from such output 12 automatically becomes an ending point 70 of the visual graphic program.

For example, as shown in FIG. 3, a determining or value test is inputted simply by selecting the determination module 20 on the command selection panel 51, an input value connected to the determination module 20 by a first commanding flow arrow 30 pointing towards the determination input 21 of the determination module 20, wherein the “True” returned value from the “True” output 22 is connected to the information input 11 of a second function module 10 by a first commanding flow arrow 30A and the “False” returned value from the “False” output 23 is connected to the information input 11′ of a second function module 10′ by a third commanding flow arrow 30B. Depending on whether the “True” returned value or the “False” returned value is returned, the program will continue to execute through the paths following the “True” or “False” returned value.

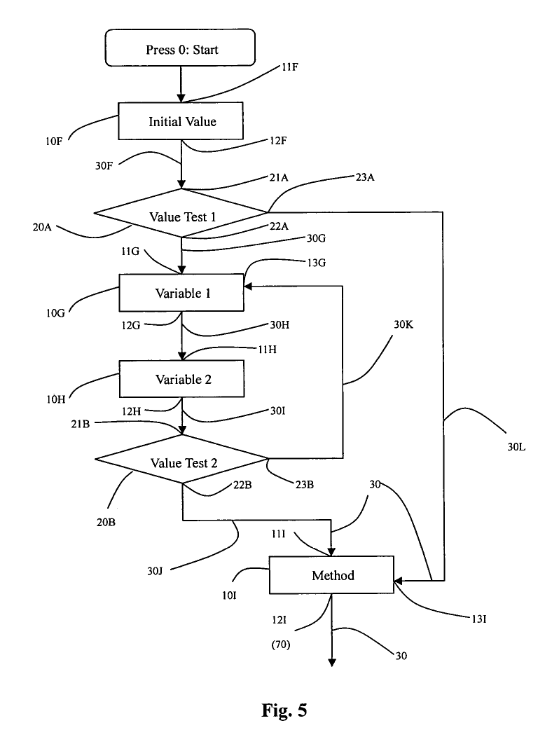

Referring to FIG. 4, a “For Loop” functional program is constructed and produced simply by selecting the following commands from the command selection panel 51 to input into the selected command panel 52:
(i) an “Initial Value” function module 10A;
(ii) a first “Variable” function module 100B which input 11B is connected with the information output 12A of the “Initial Value” function module 10A by a first commanding flow arrow 30A pointing towards the first “Variable” function module 10B;
(iii) a second “Variable” function module 10C which input 11C is connected with the information output 12B of the first “Variable” function module 10B by a second commanding flow arrow 30B pointing towards the second “Variable” function module 10C;
(iv) a “Value Test” determination module 20 which determination input 21 is connected with the information output 12C of the second “Variable” function module 10C by a third commanding flow arrow 30C pointing towards the “Value Test” determination module 20; and
(v) a “Method” function module 10D which input 11D is connected with a “True” output 22 of the “Value Test” determination module 20 by a fourth commanding flow arrow 30D pointing towards the “Method” function module 10D, in which a “False” output 23 of the “Value Test” determination module 20 is connected with another input 11B′ of the first “Variable” function module 10B by a fifth commanding flow arrow 30E, pointing towards the first “Variable” function module 10B.

Accordingly, the “For Loop” visual graphic program as shown in FIG. 4 begins with an input of Initial Value, which becomes the Variable 1. Variable 2 is obtained after incrementing Variable 1 according to the program. A Value Test is performed on Variable 2. If the value returned is true, the program continues to the next Method. If the value returned is false, the value of Variable 2 replaces the original value of Variable 1. This incrementing and replacing of value of Variable 1 continues until the returned value of the Value Test is true.

Referring to FIG. 5, a “Do-While Loop” visual graphic program is constructed and produced by selecting the following commands from the command selection panel 51 to input into the selected command panel 52:
(i) an “Initial Value” function module 10F;
(ii) a first “Value Test” determination module 20A, which determination input 21A is connected with the information output 12F of the “Initial Value” function module 10F by a first commanding flow arrow 30F pointing towards the first “Value Test” determination module 10F;
(iii) a first “Variable” function module 10G which input 11G is connected to a “True” output 22A of the first “Value Test” determination module 20A by a second commanding flow arrow 30G, pointing towards the first “Variable” function module 10G;
(iv) a second “Variable” function module 10H which input 11H is connected with the information output 12G of the first “Variable” function module 10G by a third commanding flow arrow 30H, pointing towards the second “Variable” function module 10H;
(v) a second “Value Test” determination module 20B which determination input 21B is connected with the information output 12H of the second “Variable” function module 10H by a fourth commanding flow arrow 301, pointing towards the second “Value Test” determination module 20B; and
(vi) a “Method” function module 10I which input 11I is connected with a “True” output 22B of the second “Value Test” determination module 20B by a fifth commanding flow arrow 30J, pointing towards the “Method” function module 10I, wherein a “False” output 23B of the second “Value Test” determination module 20B is connected to another input 13G of the first “Variable” function module 10G by a sixth commanding flow arrow 30K, pointing towards the first “Variable” function module 10G, wherein a “False” output 23A of the first “Value Test” determination module 20a is connected to another input 13I of the “Method” function module 10I by a seventh commanding flow arrow 30L, pointing towards the “Method” function module 101.

Accordingly, the Do-While Loop” visual graphic program as shown in FIG. 5 begins with an input of an initial value. A Value Test 1 is performed on the Initial Value, if the returned value is false, the program continues to the Method. If the returned value is true, the Initial Value becomes the value of Variable 1. Variable 2 is obtained after incrementing Variable 1 according to the program. A Value Test 2 is performed on Variable 2. If the value returned is true, the program continues to the Method. If the value returned is false, the value of Variable 2 replaces the original value of Variable 1. This incrementing and replacing of value of Variable 1 continues until the returned value of the Value Test is true.

Alternatively, the conversion rules database 40 also comprises predetermined reverse conversion instructions of converting machine readable codes to human understandable codes. When imported into the user editing interface 50, the machine readable codes of a designed program are converted to human understandable codes, and appear in the selected command panel 52 in the form of a flow chart type visual graphic display. Users can edit the designed program by adding or taking away function modules 10 and/or determination modules 20 of the designed programs through selecting modules 10, 20 from the command selection panel 23 or deleting modules 10, 20 from the selected command panel 22. By compiling and storing the edited codes, the originally designed program can now perform functions according to the preference of the user. Users can easily customize any designed programs so as to satisfy personal needs for any particular software.

For producing new software, there is no need to write the readable source codes. A set of corresponding machine readable codes of computer executable languages with value input and output is stored in a computer for each of the function modules 10 and determination modules 20. The connection of the function and determination modules 10, 20 in the visual graphic program by commanding flow arrows 30 converts and combines the sets of machines readable codes by outputting and inputting value codes between one and another in a designated manner to form the human viewable visual graphic program in the selected command panel 52 on the display 1. When the visual graphic program as shown in the selected command panel 52 is compiled by the compiler 60 in the processing unit 2, the visual graphic program is converted into machine readable codes to process correspondingly.

In other words, when the users want to amend or modify the processing machine readable codes, the users may simply add or delete the function and determination modules 10, 20 and rearrange and connect them with commanding flow arrows 30. The processing machine readable codes will accordingly be changed automatically or after the amended visual graphic program is compiled. In other words, there is no need for a programmer to learn and memorize all kinds of rules and syntax of the programming languages in order to write a program. In fact, a reasonable person who has minimum knowledge of programming, such as who can read flow c hart, c an be a programmer to write and amend a visual graphic program of the present invention. The users can change and amend their software to fit their specific personal use and operation. The programming becomes so easy and efficient by means of the visual programming method and system of the instant invention.

The visual graphic program can also be applied to existing programs by incorporating a user editing interface which provides an interface to analyze the source codes according to their different functions and determining tests programmed into different sets of source codes which are represented by the function modules 10 and the determination modules 20 correspondingly. Therefore, the existing program can also be displayed in form of visual graphic program in the selected command panel 52 by connecting function modules 10 and determination modules 20 by commanding flow arrows 30 in a corresponding pattern. When the users want to amend the program, the users may also simply add or delete the function and determination modules 10, 20 and rearrange and connect them with commanding flow arrows 30. A compiler 60 is also incorporated in the existing program and the source codes will be changed correspondingly by means of the user editing interface after the amended visual graphic program is compiled by the compiler 60. The machine readable codes will be changed according to the new source codes.

By means of the visual programming system described above, a program can be produced by a visual programming method without the need of writing source codes, wherein the visual programming method comprises the steps of:
(a) assigning one or more function modules 10 each of which is provided with an applicable functional program or command stored in computer executable language in a processing unit 2 to accomplish a substantial applicable function;
(b) assigning one or more determination modules 20 each of which is provided with a determining test stored in computer executable language in the processing unit 2;
(c) connecting the function modules 10 and determination modules 20 in a predetermined sequence with commanding flow arrows 30 each pointing from one direction to another to construct a visual graphic program; and
(d) compiling the visual graphic program to machine readable codes by sending information outputted from each of the function modules 10 and determination modules 20 to input into another the function module 10 or determination module 20 that is connected thereto by the commanding flow arrows 30 so as to construct a finish program in the computer executable language in the processing unit 2.

As disclosed above, each of the function modules 10 has an input 11 and an output 12 for information and each of the determination modules 20 has a determination input 21, a “True” output 22 and a “False” output 23.

In the step (d), when a first function module 10 is connected to a second function module 10 by a commanding flow arrow 30 having one end starting from the information output 12 of the first function module 10 and another end pointing towards input 11 of the second function module 10, information in machine readable codes outputted from the first function module 10 is inputted into the second function module 10 after the visual graphic program is compiled.

When a function module 10 is connected to a determination module 20 by a commanding flow arrow 30 having one end starting from the information output 12 of the function module 10 and another end pointing towards the determination input 21 of the determination module 20, information in machine readable codes is outputted from the function module 10 and inputted into the determination module 20 for determining test after the visual graphic program is compiled.

When a determination module 10 is connected to two function modules 10 by two commanding flow arrows 30 having ends respectively starting from the “True” output 22 and “False” output 23 and other ends respectively pointing towards the information inputs 11 of the two function modules 10, information in machine readable codes is output from the determination module 20 and inputted into the respective function module 10 after the visual graphic program is compiled.

When a first determination module 20 is connected to at least a second determination module 20 by a commanding flow arrow 30 having one end starting from either the “True” output 22 or the “False” output 23 of the first determination module 20 and another end pointing towards the determination input 21 of the second determination module 20, information in machine readable codes is outputted from the first determination module 20 and inputted into the second determination module 20.

To amend a visual graphic program of the present invention is as simple as by:
(i) adding one or more function modules 10 or determination modules 20 and connecting them with the specific function modules 10 or determination modules 20 in the visual graphic program with one or more commanding flow arrows 30; or
(ii) deleting one or more function module 10 or determination modules 20 from the visual graphic program and rearranging the commanding flow arrows 30; or
(iii) replacing one or more function modules 10 or determination modules 20 with other function modules or determination modules with other applicable functional programs or commands or determining tests.

In view of the operation by a user, the present invention further provides a method of allowing computer programs to be inputted without using advanced programming languages, comprising the steps of:
(a) establishing a conversion rule database containing conversion instructions of converting selectable commands to machine readable codes;
(b) providing a selection platform, wherein the selectable commands are listed out for a user to select a set of selected commands according to a desired flow of functions to be performed; and
(c) compiling the selected commands into machine readable codes according to the set of conversion instructions.

In addition, before the step (c), the method further comprises a sub-step of storing the selected commands inside a processing unit.

In view of an existing program for user, the present invention provides a method of allowing a designed computer program to be customized without using advanced programming languages, comprising the steps of:
(a) establishing a reverse conversion rule database containing reverse conversion instructions of reverse converting machine readable codes of the designed computer program to human understandable codes;
(b) establishing a set of conversion rule database containing conversion instructions of converting selectable commands to machine readable codes;
(c) providing an imported code viewing platform, wherein the machine readable codes of the designed computer program are converted to and listed out as the human understandable codes according to the reversion conversion instructions;
(d) providing an editing platform, wherein selectable commands are listed out for a user to insert selected commands into the human understandable codes and deleting sections of the human understandable codes, forming a set of edited codes, according to a desired flow of functions to be performed; and
(e) compiling the edited codes into machine readable codes following the set of conversion rules.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A visual programming system, comprising:
one or more function modules each of which is provided with an applicable functional programming command stored in a computer executable language in a processing unit to accomplish a substantial applicable function; and
one or more commanding flow arrows connecting the function modules with each other in a predetermined sequence to construct a visual graphic program which is compiled to machine readable codes of said computer executable language, wherein information outputted from said applicable functional programming command of one of said function modules is inputted to another said applicable functional programming command of another said function module that is connected with said one of said function modules by said commanding flow arrow, so as to construct said visual graphic program in said computer executable language in said processing unit.

2. The system, as recited in claim 1, further comprising one or more determination modules each of which is provided with a determining test stored in computer executable language in the processing unit, wherein each of said determination modules is connected with three of said function modules and other said determination modules at an determination input, a “True” output and a “False” output thereof by three of said commanding flow arrows to construct said visual graphic program, wherein after said visual graphic program is compiled to machine readable codes, each of said determination modules conducts said determining test to send information inputted selectively to said function module or said determination module connected to said “True” output and said “False” output.

3. The system, as recited in claim 1, wherein each of said function modules has at least an information input for inputting information and an information output for outputting computed information, wherein when said commanding flow arrow has an arrow end connected to said information input of one of said function modules and another starting end connected to said information output of another said function module, information inputs to said applicable functional programming command of said function module from said another function module that outputs said information.

4. The system, as recited in claim 2, wherein each of said function modules has at least an information input for inputting information and an information output for outputting computed information, wherein when said commanding flow arrow has an arrow end connected to said information input of one of said function modules and another starting end connected to said information output of another said function module, information inputs to said applicable functional programming command of said function module from said another function module that outputs said information.

5. The system, as recited in claim 2, wherein each of said function modules has at least an information input for inputting information from one of said determination modules, when said commanding flow arrow has an arrow end connected to said information input of one of said function modules and another starting end connected to either said “True” output or said “False” output of said determination module, information inputs to said applicable functional programming command with respect to said function module from said determination module that outputs said information.

6. The system, as recited in claim 1, wherein a construction of said function modules, said determination modules and said commanding flow arrows is displayed by said processing unit via a monitor thereof as said visual graphic program which directly represents said computer executable language to be stored in said processing unit to operate and function.

7. The system, as recited in claim 4, wherein a construction of said function modules, said determination modules and said commanding flow arrows is displayed by said processing unit via a monitor thereof as said visual graphic program which directly represents said computer executable language to be stored in said processing unit to operate and function.

8. The system, as recited in claim 5, wherein a construction of said function modules, said determination modules and said commanding flow arrows is displayed by said processing unit via a monitor thereof as said visual graphic program which directly represents said computer executable language to be stored in said processing unit to operate and function.

9. The system, as recited in claim 1, wherein human readable source codes of a source code program are converted and arranged into different said function modules of said visual graphic program according to a conversion rules database.

10. The system, as recited in claim 4, wherein human readable source codes of a source code program are converted and arranged into different said function modules and said determination modules of said visual graphic program according to a conversion rules database.

11. The system, as recited in claim 5, wherein human readable source codes of a source code program are converted and arranged into said different function modules and said determination modules of said visual graphic program according to a conversion rules database.

12. The system, as recited in claim 1, further including a user editing interface to construct said visual graphic program by selecting said function modules and linking said selected function modules by said commanding flow arrows, and a compiler which is used to convert said human readable source code program into said machine readable codes of said computer executable language following predetermined conversion instructions of a conversion rules database.

13. The system, as recited in claim 4, further including a user editing interface to construct said visual graphic program by selecting said function modules and said determination modules and linking said selected function modules and determination modules by said commanding flow arrows, and a compiler which is used to convert said human readable source code program into said machine readable codes of said computer executable language following predetermined conversion instructions of a conversion rules database.

14. The system, as recited in claim 5, further including a user editing interface to construct said visual graphic program by selecting said function modules and said determination modules and linking said selected function modules and determination modules by said commanding flow arrows, and a compiler which is used to convert said human readable source code program into said machine readable codes of said computer executable language following predetermined conversion instructions of a conversion rules database.

15. The system, as recited in claim 9, further including a user editing interface to construct said visual graphic program by selecting said function modules and linking said selected function modules by said commanding flow arrows, and a compiler which is used to convert said human readable source code program into said machine readable codes of said computer executable language following predetermined conversion instructions of said conversion rules database.

16. The system, as recited in claim 10, further including a user editing interface to construct said visual graphic program by selecting said function modules and said determination modules and linking said selected function modules and determination modules by said commanding flow arrows, and a compiler which is used to convert said human readable source code program into said machine readable codes of said computer executable language following predetermined conversion instructions of said conversion rules database.

17. The system, as recited in claim 11, further including a user editing interface to construct said visual graphic program by selecting said function modules and said determination modules and linking said selected function modules and determination modules by said commanding flow arrows, and a compiler which is used to convert said human readable source code program into said machine readable codes of said computer executable language following predetermined conversion instructions of said conversion rules database.

18. The system, as recited in claim 12, wherein said user editing interface comprises a command selection panel, a selected command panel, and a file management panel, wherein said command selection panel comprises selectable commands, including determining test commands in human readable programming languages, commanding flow arrows representing direction of flow of said program and functional commands, wherein when a command is selected from said command selection panel, said selected command appears in said selected command panel and, by arranging selected commands into a flow chart form, said visual graphic program is completed.

19. The system, as recited in claim 13, wherein said user editing interface comprises a command selection panel, a selected command panel, and a file management panel, wherein said command selection panel comprises selectable commands, including determining test commands in human readable programming languages, commanding flow arrows representing direction of flow of said program and functional commands, wherein when a command is selected from said command selection panel, said selected command appears in said selected command panel and, by arranging selected commands into a flow chart form, said visual graphic program is completed.

20. The system, as recited in claim 14, wherein said user editing interface comprises a command selection panel, a selected command panel, and a file management panel, wherein said command selection panel comprises selectable commands, including determining test commands in human readable programming languages, commanding flow arrows representing direction of flow of said program and functional commands, wherein when a command is selected from said command selection panel, said selected command appears in said selected command panel and, by arranging selected commands into a flow chart form, said visual graphic program is completed.

21. The system, as recited in claim 15, wherein said user editing interface comprises a command selection panel, a selected command panel, and a file management panel, wherein said command selection panel comprises selectable commands, including determining test commands in human readable programming languages, commanding flow arrows representing direction of flow of said program and functional commands, wherein when a command is selected from said command selection panel, said selected command appears in said selected command panel and, by arranging selected commands into a flow chart form, said visual graphic program is completed.

22. The system, as recited in claim 16, wherein said user editing interface comprises a command selection panel, a selected command panel, and a file management panel, wherein said command selection panel comprises selectable commands, including determining test commands in human readable programming languages, commanding flow arrows representing direction of flow of said program and functional commands, wherein when a command is selected from said command selection panel, said selected command appears in said selected command panel and, by arranging selected commands into a flow chart form, said visual graphic program is completed.

23. The system, as recited in claim 17, wherein said user editing interface comprises a command selection panel, a selected command panel, and a file management panel, wherein said command selection panel comprises selectable commands, including determining test commands in human readable programming languages, commanding flow arrows representing direction of flow of said program and functional commands, wherein when a command is selected from said command selection panel, said selected command appears in said selected command panel and, by arranging selected commands into a flow chart form, said visual graphic program is completed.

24. A visual programming method, comprising:
(a) assigning one or more function modules each of which is provided with an applicable functional programming command stored in a computer executable language in a processing unit to accomplish a substantial applicable function; and
(b) connecting said function modules in a predetermined sequence with one or more commanding flow arrows, each pointing from one direction to another to construct a visual graphic program; and
(c) compiling said visual graphic program to machine readable codes of said computer executable language by inputting information outputted from said applicable functional programming command of one of said function modules to another said applicable functional programming command of another said function module that is connected with said one of said function modules by said commanding flow arrow, so as to construct said visual graphic program in said computer executable language in said processing unit.

25. The method, as recited in claim 24, after the step (a), further comprising a step of assigning one or more determination modules each of which is provided with a determining test stored in said computer executable language in said processing unit, wherein each of said determination modules is connected with three of said function modules and other said determination modules at an determination input, a “True” output and a “False” output thereof by three of said commanding flow arrows to construct said visual graphic program, wherein after said visual graphic program is compiled to said machine readable codes, each of said determination modules conducts said determining test to send information inputted selectively to said function module or said determination module connected to said “True” output and said “False” output.

26. The method, as recited in claim 24, wherein each of said function modules has at least an information input for inputting information and an information output for outputting computed information, wherein when said commanding flow arrow has an arrow end connected to said information input of one of said function modules and another starting end connected to said information output of another said function module, information inputs to said applicable functional programming command of said function module from said another function module that outputs said information.

27. The method, as recited in claim 2, wherein each of said function modules has at least an information input for inputting information and an information output for outputting computed information, wherein when said commanding flow arrow has an arrow end connected to said information input of one of said function modules and another starting end connected to said information output of another said function module, information inputs to said applicable functional programming command of said function module from said another function module that outputs said information.

28. The method, as recited in claim 25, wherein each of said function modules has at least an information input for inputting information from one of said determination modules, when said commanding flow arrow has an arrow end connected to said information input of one of said function modules and another starting end connected to either said “True” output or said “False” output of said determination module, information inputs to said applicable functional programming command with respect to said function module from said determination module that outputs said information.

29. The method, as recited in claim 25, wherein human readable source codes of a source code program are converted and arranged into different said function modules and said determination modules of said visual graphic program according to a conversion rules database.

30. The method, as recited in claim 28, wherein human readable source codes of a source code program are converted and arranged into different said function modules and said determination modules of said visual graphic program according to a conversion rules database.

31. The method, as recited in claim 29, wherein said visual graphic program is constructed by a user editing interface by selecting said function modules and said determination modules and linking said selected function modules and determination modules by said commanding flow arrows, and said human readable code program is converted by a compiler into machine readable codes of said computer executable language following predetermined conversion instructions of said conversion rules database.

32. The method, as recited in claim 30, wherein said visual graphic program is constructed by a user editing interface by selecting said function modules and said determination modules and linking said selected function modules and determination modules by said commanding flow arrows, and said human readable code program is converted by a compiler into machine readable codes of said computer executable language following predetermined conversion instructions of said conversion rules database.

33. A method of allowing computer programs to be inputted without using advanced programming languages, comprising the steps of:
(a) establishing a conversion rule database containing conversion instructions of converting selectable commands to machine readable codes;
(b) providing a selection platform, wherein said selectable commands are listed out for a user to select a set of selected commands according to a desired flow of functions to be performed; and
(c) compiling said selected commands into machine readable codes according to said set of conversion instructions.

34. The method, as recited in claim 33, before the step (c), further comprising a sub-step of storing said selected commands inside a processing unit.

35. A method of allowing a designed computer program to be customized without using advanced programming languages, comprising the steps of:
(a) establishing a reverse conversion rule database containing reverse conversion instructions of reverse converting machine readable codes of said designed computer program to human understandable codes;
(b) establishing a set of conversion rule database containing conversion instructions of converting selectable commands to machine readable codes;
(c) providing an imported code viewing platform, wherein said machine readable codes of said designed computer program are converted to and listed out as said human understandable codes according to said reversion conversion instructions;
(d) providing an editing platform, wherein selectable commands are listed out for a user to insert selected commands into said human understandable codes and deleting sections of said human understandable codes, forming a set of edited codes, according to a desired flow of functions to be performed; and
(e) compiling said edited codes into machine readable codes following said set of conversion rules.
